(19) United States
(12) Patent Application Publication
(10) Pub. No.: US 2022/0189343 A1
(43) Pub. Date: Jun. 16, 2022

(54) ARTIFICIAL ORGAN MODEL, METHOD FOR PRODUCING SAME, AND METHOD FOR TRAINING SURGICAL TECHNIQUES USING ARTIFICIAL ORGAN MODEL

(71) Applicant: EBM CORPORATION, Tokyo (JP)

(72) Inventor: Young-Kwang PARK, Tokyo (JP)

(21) Appl. No.: 17/310,720

(22) PCT Filed: Feb. 19, 2020
(86) PCT No.: PCT/JP2020/006494

§ 371 Date: Aug. 19, 2021

(30) Foreign Application Priority Data
Feb. 20, 2019 (JP) 2019-028111

(51) Int. Cl. G09B 23/30

(52) U.S. Cl. CPC G09B 23/30; A01G 18/00

(57) ABSTRACT

To provide an artificial tissue model that can be more advantageously used in surgical technique training, as well as a method of fabricating the same. The present invention provides an artificial organ model for surgical training, the model containing a naturally grown or cultivated mushroom. The mushroom forming the raw material is shaped, colored, and subjected to a softening treatment to fabricate an artificial organ that imitates or reproduces all or part of an organ to be modeled, such as the brain, the liver, the heart, a blood vessel, the neck, the chest, the abdomen, the arm, the thigh, a ureter, a nerve, a lymphatic vessel, the intestinal tract, or the like.

### FIELD OF THE INVENTION

The present invention pertains to an artificial organ model for training in surgical techniques and evaluating medical device performance, a method for fabricating the same, and a surgical technique training method that uses the artificial organ model.

### BACKGROUND OF THE INVENTION

Taking surgical procedures that demand high levels of surgical skill, such as heart surgery, as an example, 50,000 surgical procedures are performed annually in Japan. However, there are numerous (about 600) hospitals throughout the country, among which these cases are distributed. There are also numerous specialists in cardiovascular surgery—about 2,000. There is also a tendency for cases to be concentrated in the hands of a few experienced surgeons, and young heart surgeons in particular handle only very small numbers of cases, no more than ten annually.

In addition, operable cases have become increasingly difficult due to older patient age, increased frequency of repeat surgery, the spread of off-pump coronary artery bypasses, the increased severity of surgical cases resulting from advances in internal treatments such as stents, and so forth. As a result, young heart surgeons have even fewer chances to operate.

In order to compensate for this reduction in surgical experience, technique training is typically performed using organs from pigs and other animals (“wet labs”), and simulators and other artificial organ models and model organs (“dry labs”). There are also cases, albeit few in number, of training being performed using live pigs and other animals (“animal labs”). One method for training in ITA dissection as part of coronary artery bypass procedures is to use chunks of pork or beef rib meat, and dissect blood vessels running through the interior of the meat. However, methods utilizing animal organs present storage-related, sanitary, and ethical problems. Common bacteria, coliform bacteria, Escherichia coli, Staphylococcus aureus, and the like are present in animal-based surgical training or medical device evaluation models, and present major sanitary problems, such as the risk of infection, when used in a hospital setting. In room temperature environments, moreover, such models decompose over time during the surgical training or medical device evaluation, and odor becomes a particular problem.

The wet labs, dry labs, etc., described are performed over different lengths of time and in different environments from clinical work performed on actual patients, and thus are collectively referred to as off-the-job training (off-JT).

In 2017, the Japanese Board of Cardiovascular Surgery instituted a requirement for 30 hours of off-JT experience for certification of specialists in cardiovascular surgery. Off-JT is rapidly spreading as a means for training surgical skills and fostering surgeons in settings that present no risks to patients.

There has been a transition to dry labs due to the sanitary problems, such as Escherichia coli and other viruses peculiar to live animals, and ethical problems presented by wet labs and animal labs as means for off-JT.

Artificial organ models used in dry labs include models used to practice dissection techniques, incision techniques, anastomosis techniques, and suturing techniques. Organs and tissues used to train in these techniques include skin, blood vessels, intestines, adipose tissue, and connective tissue surrounding organs, for each of which distinctive models have been developed.

Models made from silicone, urethane elastomer, styrene elastomer, hydrogels such as polyvinyl alcohol, and fibrous structures have been proposed as materials for these artificial organ models.

Examples of patents that disclose such prior art include Japanese Patents 6055069 (P6055069) and 5759055 (P5759055). These prior-art models are formed from layers of hydrogel, and have structures suitable for training in dissection techniques using energy devices such as electric scalpels. Organ models constituted by layered gel products of this sort, which are formed from polyvinyl alcohol and other hydrogels that have their own individual properties, are comparatively well-suited to such training, as they offer a sensation similar to that of cutting into human tissue despite being man-made.

There is a demand for a model that reproduces the mechanical strength of tissue, the electrical conductivity of the human body, and the orientation of human tissue to loads (the longitudinal strength of tissues having fibrous structures, such as muscle, and the structural weakness thereof against loads that tear the fibers apart) for training in dissection, incision, suturing, and anastomosis, techniques that are fundamental to the field of surgical procedures in general.

Methods that have been used to reproduce the characteristics of human and biological tissue include embedding fibers in hydrogels and other gel materials, and impregnating fibrous structures with electroconductive gels having liquid form. In all of these methods, fibrous materials are used in combination with other materials, such as elastomers and gels, to reproduce the characteristics, such as the structural strength and electrical conductivity, of the target organ or tissue.

### SUMMARY OF THE INVENTION

### Problem to be Solved by the Invention

However, the existing artificial organ models described above continue to be inadequate for reproducing actual organs; thus, there is a demand for the development of an artificial organ model that is better suited for training in surgical techniques.

Establishing visual access is particularly essential in surgical procedures in order to expose the target organ and obtain a good surgical view, and there is a demand for the development of an artificial organ model that is inexpensive and strong enough to withstand the suturing and retraction required to establish visual access in order to practice this process.

The present invention was conceived in view of these circumstances, and has an object of providing an artificial tissue model and an organ model that can be more advantageously used in surgical technique training compared to previous artificial tissues, as well as a method for fabricating the same.

### Means for Solving the Problem

As the result of trial and error in order to improve the ability, during surgical technique training, to imitate the experience of incising actual human organs, the inventors made discoveries regarding an artificial organ model that is highly capable of imitating organ membrane dissection, and engaged in dedicated development to produce actual prototypes, thereby arriving at the present invention.

Specifically, there is provided, in accordance with a main aspect of the present invention, an artificial organ model for surgical training or medical device evaluation, the model containing a naturally grown or cultivated mushroom.

By using mushrooms as a material to form the artificial organ model, it is possible to obtain an artificial organ model for surgical training or medical device evaluation that is characterized by imitating a part or all of the brain, the liver, the heart, a blood vessel, the neck, the chest, the abdomen, the arm, the thigh, a ureter, a nerve, a lymphatic vessel, the intestinal tract, or the like. As used herein, “mushrooms” is a colloquial appellation for macroscopic fungal fruiting bodies or basidiocarps. Mushrooms are composed of about 90% water, and are made up of proteins, fiber, carbohydrates, and so forth. Mushrooms are formed from hyphae. Hyphae are generally filamentous, branched structures that grow from their tips and break down and absorb the surrounding substrate on their surfaces for nutrition. Many fungi form such structures after germinating from spores, and continue to grow and branch to develop a mass formed from multiple hyphae. Hyphae are formed from cells, the surfaces of which are covered by a tough cell wall. Thickness ranges from 0.5 to 100 μm, varying greatly between fungal colonies. In other words, a mushroom is a mass of hyphae that comprise cell walls, and is structurally oriented and electrically conductive. Meanwhile, the myofibrils that make up muscle fibers in the human body are about 0.5-2 μm thick, and have cylindrical structures that are aligned in the longitudinal direction of the muscle fiber. Focusing on the extreme structural similarity between mushrooms and muscle fibers, the inventors, through trial and error, repeatedly processed and tested mushrooms as a material for an artificial organ model, ultimately arriving at the present invention.

Accordingly, the following embodiments of the present invention are possible.

(1) An artificial organ model for surgical training, the model being characterized by comprising a naturally grown or cultivated mushroom.

(2) The artificial organ model according to (1), wherein:

the mushroom is shaped to a shape and size suitable for a specific organ being modeled, and is selectively colored before being subjected to a softening treatment;

thereby being processed so as retain material properties suitable for the organ being modeled.

(3) The artificial organ model according to (2), wherein:

the softening treatment is heating the mushroom to a specific temperature for a specific length of time.

(4) The artificial organ model according to (3), wherein:

the heating treatment is introducing the mushroom into water heated to 80° C. or higher for at least 60 seconds.

(5) The artificial organ model according to (2), wherein:

the mushrooms are freeze-dried after being subjected to the aforementioned process.

(6) The artificial organ model according to (2), wherein:

the mushroom has been impregnated with a preservative solution and subjected to a preservative treatment.

(7) The artificial organ model according to (6), wherein: the preservative solution is an aqueous solution of sodium hypochlorite, acidic water, an aqueous solution of sodium bicarbonate, an aqueous solution of chlorine dioxide, or PHMB (polyhexamethylene biguanide).

(8) The artificial organ model according to (1), wherein:

the mushroom comprises a narrow stem-like stalk, which is used to model a thread-shaped organ such as a blood vessel, a nerve, a ureter, a lymphatic vessel, or the like.

(9) The artificial organ model according to (8), wherein:

the narrow stem-like stalk is split along fibers thereof to imitate a branched thread-shaped organ model.

(10) The artificial organ model according to (8), wherein:

a plurality of the narrow stem-like stalks is linked to imitate a branched thread-shaped organ.

(10) The artificial organ model according to (8), wherein:

the thread-shaped organ modeled using the mushroom is anchored to a substrate or in the interior thereof.

(11) The artificial organ model according to (10), wherein:

the substrate is formed by working a stalk of a mushroom other than that used to model the thread-shaped organ into a flat shape.

(12) The artificial organ model according to (1), wherein:

the mushroom has a hollow shape.

(13) The artificial organ model according to (1), wherein:

The specific organ being modeled is a part or all of the brain, the liver, the heart, a blood vessel, the neck, the chest, the abdomen, the arm, the thigh, a ureter, a nerve, a lymphatic vessel, the intestinal tract, or the like.

(14) The artificial organ model according to (1), wherein:

the mushroom is a fruiting body or basidiocarp.

(15) The artificial organ model according to (1), wherein:

the model is impregnated or coated with one or more of a polymer solution, a monomer solution, a hydrogel, a hydrosol, and an emulsion.

(16) The artificial organ model according to (2), wherein:

the model comprises two or more different model organs modeled using two or more mushrooms; and the two or more model organs are stacked in layers.

(17) A method of fabricating an artificial organ model, the method comprising: a step of shaping a specific type of mushroom into a shape a size suitable for a desired organ being modeled;

a step of selectively coloring the shaped mushroom with a color suitable for the organ being modeled; and

a step of performing a softening treatment upon the mushroom so that the mushroom retains material properties suitable for the organ being modeled.

(18) The method of fabricating an artificial organ model according to (17), wherein: the softening treatment is heating the mushroom to a specific temperature for a specific length of time.

(19) The method of fabricating an artificial organ model according to (18), wherein: the heating treatment is introducing the mushroom into water heated to 80° C. or higher for at least 60 seconds.

(20) The method of fabricating an artificial organ model according to (17), further comprising: a step of freeze-drying the processed mushroom.

(21) The method of fabricating an artificial organ model according to (17), further comprising: a step of impregnating the mushroom with a preservative solution and subjecting the mushroom to a preservative treatment.

(22) The method of fabricating an artificial organ model according to (21), wherein: the preservative solution is an aqueous solution of sodium hypochlorite, acidic water, an aqueous solution of sodium bicarbonate, an aqueous solution of chlorine dioxide, or PHMB (polyhexamethylene biguanide).

(23) The method of fabricating an artificial organ model according to (17), wherein: the mushroom comprises a narrow stem-like stalk, which is used to model a thread-shaped organ such as a blood vessel, a nerve, a ureter, a lymphatic vessel, or the like.

(24) The method of fabricating an artificial organ model according to (23), the method comprising:

a step of splitting the narrow stem-like stalk along fibers thereof to imitate a branched thread-shaped organ model.

(25) The method of fabricating an artificial organ model according to (23), the method comprising:

a step of linking a plurality of the narrow stem-like stalks to imitate a branched thread-shaped organ.

(26) The method of fabricating an artificial organ model according to (23), the method comprising:

a step of anchoring the thread-shaped organ modeled using the mushroom to a substrate or in the interior thereof.

(27) The method of fabricating an artificial organ model according to (25), wherein: the substrate is formed by working a stalk of a mushroom other than that used to model the thread-shaped organ into a flat shape.

(28) The method of fabricating an artificial organ model according to (17), further comprising: a step of impregnating or coating the model with one or more of a polymer solution, a monomer solution, a hydrogel, a hydrosol, and an emulsion.

(29) The method of fabricating an artificial organ model according to (17), the method comprising:

a step of stacking in layers two or more different model organs modeled using two or more mushrooms.

Other characteristics of the present invention will be made apparent in the following embodiments and drawings.

### BRIEF DESCRIPTION OF THE DRAWINGS

FIG. 1 is a schematic diagram of one embodiment of the present invention.

FIG. 2 is a schematic diagram of a method of fabricating the same.

FIG. 3 is a flowchart of a method of fabricating the same.

FIG. 4 is a schematic diagram of artificial organs modeling thread-shaped organs in the present invention.

FIG. 5 is a schematic diagram of another embodiment of an artificial organ according to the present invention.

FIG. 6 is a schematic diagram of another embodiment of an artificial organ according to the present invention.

FIG. 7 is a schematic diagram of another embodiment of an artificial organ according to the present invention.

FIG. 8 is a schematic diagram of another embodiment of an artificial organ according to the present invention.

FIG. 9 is a schematic illustration of an example of surgical technique training according to the present invention.

FIG. 10 is a schematic illustration of an example of surgical technique training according to the present invention.

FIG. 11 is a schematic illustration of an example of surgical technique training according to the present invention.

FIG. 12 is a schematic diagram of an applied example of the present invention.

### DETAILED DESCRIPTION OF THE INVENTION

An embodiment of the present invention will now be described with respect to the attached drawings.

### 1. Configuration of the Present Invention (First Example)

The present invention is an artificial organ model for surgical training, the model being characterized by comprising a naturally grown or cultivated mushroom.

Mushrooms exhibit fiber orientation; for example, king oyster mushrooms, enoki mushrooms, and the like are strong against tensile forces along the direction of the fibers, but are extremely weak against longitudinal tearing forces. These mechanical properties are highly similar to those of living bodies of animals, making mushrooms ideal for artificial organ models.

This structural description will feature a first example in which a king oyster mushroom is used. The king oyster is a species of mushroom in genus Pleurotus, family Pleurotaceae. The fruiting bodies are edible, inexpensive, and readily obtainable. In Japan, they are cultivated in dark rooms to lengthen the stem portions. They are comparatively large for edible mushrooms, with a maximum length of 59 cm and a weight of 3.58 kg having been reported.

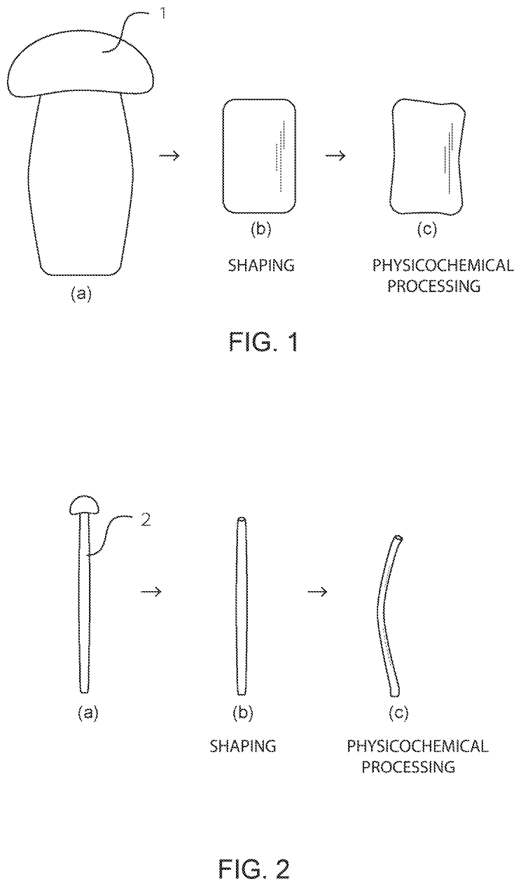

FIG. 1 is a schematic view of an artificial organ fabricated using a king oyster mushroom. A king oyster mushroom having the shape labeled by 1 in FIG. 1(a) is used for this artificial organ; the mushroom is cut to a suitable size, as shown in FIG. 1(b), then subjected to physicochemical treatments such as coloring and heating, as shown in FIG. 1(c).

In this example, the finished artificial organ (FIG. 1(c)) is 4 cm in diameter and 10 cm in length, is electrically conductive, and has the anisotropic mechanical/structural strength of a mushroom; i.e., strong against loads along the direction of the fibers, but weak against loads that pull the fibers apart, that is, in the circumferential direction. As discussed above, these properties are highly similar to muscle fibers and muscle tissue in particular, which is ideal for an artificial organ for surgical technique training.

### 2. Fabrication Method of the Present Invention (Second Example)

Next, a method of fabricating the artificial organ model of the present invention will be described.

As opposed to the king oyster used in the foregoing structural description, an enoki mushroom, labeled “2” in FIG. 2, is used in this example. Here, a method for obtaining an internal thoracic artery model using a king oyster mushroom and an enoki mushroom will be described.

The enoki (scientific name: Flammulina velutipes (Curt.:Fr.) Sing.), also known in Japanese as enokitake, enokidake, nametake, namesusuki, and yukinoshita, is a species of mushroom in family Physalacriaceae that has been eaten by humans since ancient times, most commonly simply referred to as “enoki” in culinary contexts in particular.

The stalk of the enoki 2 is generally 2-9 cm tall and 1-8 mm in diameter, and is hollow and fibrous. The stalk has a substantially uniform thickness from top to bottom.

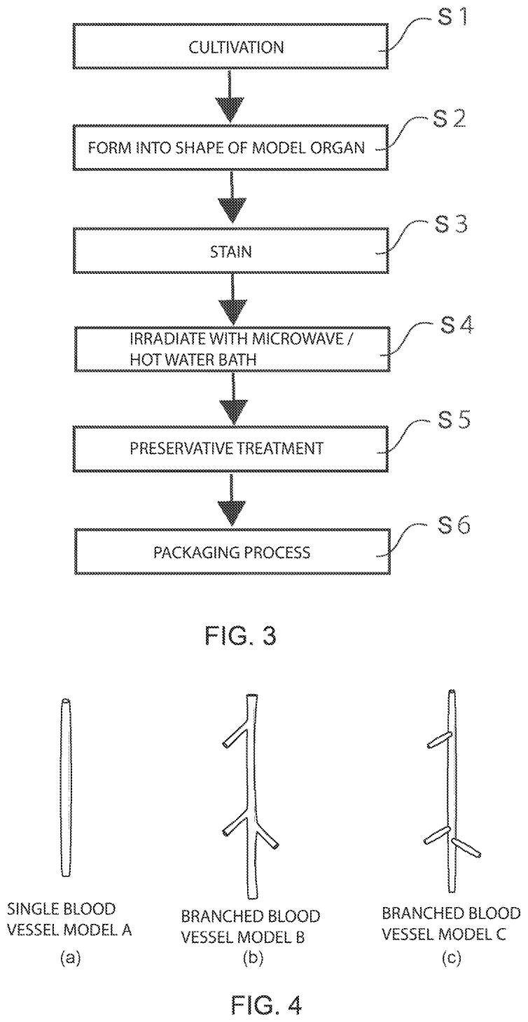

FIG. 3 is a flowchart of a fabrication process.

In this embodiment, the enoki 2 is cultivated in step S1 in growing conditions adjusted to yield a size suitable for an artificial organ. For example, the mushrooms are thinned to a greater extent than in ordinary growing conditions, and the growth period lengthened, to obtain an enoki 2 having a stalk about 30 cm in length, which is about three times the aforementioned maximum length, and corresponds to the diameter and length of the human internal thoracic artery (ITA).

The enoki 2 can be used in either hollow or solid form. For ITA dissection technique training, either a hollow or a solid form may be used. A hollow form is preferable for uses in which anastomosis technique training is a goal.

Next, the cap of the enoki 2 obtained in step S1 is removed to create a hollow or solid, uniform, elongated cylindrical shape (step S2). The enoki 2 is thus shaped into the shape of the model organ to be fabricated.

Next, in step S3, the enoki 2 (or capped enoki 1) or a king oyster 4 (or capped king oyster 3) is immersed in a solution of a dye such as red food coloring to impregnate the interior of the structure with the solution. Five minutes or more of immersion will be sufficient to uniformly dye an enoki mushroom having a diameter of about 2-3 mm through to its interior. In this way, tissues can be selectively and distinctively reproduced using red colors for blood vessels, white or milky white for nerves and ureters, and purple and blue colors for veins. In this case, red food coloring is used to dye the mushroom red to reproduce the internal thoracic artery. Visibility to the surgeon and a realistic visual appearance are also vital elements of an organ model for surgical training, and the color contrast between the target organ and surrounding organs serves as a guide for positioning during dissection and vessel harvesting.

Next, in step S4, the organ model is irradiated with microwav at 200 W for 60 seconds. This reduces the structural strength of the enoki 2 (softening treatment). The treatment is not limited to microwaving; any treatment by which the cell walls can be suitably disrupted, such as a hot water bath, is acceptable. In the case of a hot water bath, the organ model is placed for 60 seconds or longer in water heated to at least 80°.

In step S5, a preservative treatment is performed. Specifically, the organ model is immersed for at least 10 minutes in a room temperature sterilizing solution 5, such as a 1% aqueous solution of sodium hypochlorite, to sterilize the surface and interior of the enoki 2 (or capped enoki 1) or king oyster 4 (or capped king oyster 3) and improve shelf life. EOG, electron beam sterilization, or low-temperature sterilization by holding at 60° C. for at least two hours may be performed as a preservative treatment after the packaging described in S6.

As part of the preservative treatment, freeze-drying is performed for the sake of long-term storage.

Finally, in step S6, vacuum packing is performed as a packaging process. This prevents contamination by external microorganisms, prevents oxidation and desiccation, and makes it possible to improve shelf life and stability of product quality.

### 3. Examples of the Present Invention as Applied to Various Types of Surgical Technique Training

Next, examples of the mushroom-based artificial organ model according to this embodiment of the present invention as applied to various types of surgical technique training will be described.

### 3(1) Applied Example 1: Training in ITA Dissection Techniques for Coronary Artery Bypass Surgery (Third Example)

3(1)(a) Training in ITA Dissection Techniques for Coronary Artery Bypass Surgery

Coronary artery bypass surgery is a common procedure in the field of heart surgery in which a healthy graft vessel (replacement vessel) is anastomosed distally to a stenotic coronary artery to reestablish circulation. The internal thoracic artery (ITA or IMA), greater saphenous vein (SVG), gastroepiploic arteries (GEA), and so forth are primarily used as graft vessels. Obtaining the internal thoracic artery, for example, demands the surgical technique of dissecting the internal thoracic artery constituting the target vessel from fat and other connective tissue.

The internal thoracic artery has an outer diameter of about 1.5-3.0 mm, and comprises multiple branches about 0.1-1.0 mm in size. The surgeon cuts and ligates groups of branches to prevent hemorrhaging while progressively dissecting the trunk of the internal thoracic artery. During this process, an energy device in the form of a harmonic scalpel or an electric scalpel is used to perform the dissection.

Branches are processed via different methods depending on whether the surgery is being performed by a robot or under direct view by a surgeon. In robotic surgery, the branch is clipped proximally and distally of the planned cutting plane to prevent bleeding. Next, the cutting plane is cut using an electric scalpel or scissors.

Typical direct-view surgical procedures differ somewhat depending on whether a harmonic scalpel or an electric scalpel is used to perform dissection. A harmonic scalpel has protein-coagulating action, and thus is used on its own to cut branches. Bleeding from the branches is prevented by the coagulated blood. When dissection is performed using an electric scalpel, the process will differ depending on the diameter of the branch. Comparatively large branches (about 0.5-1.0 mm) are ligated to prevent bleeding, then cut. Comparatively small branches (about 0.5 mm or less) are cut and cauterized while using the coagulatory function of an electric scalpel to coagulate blood.

Damage to the trunk of a vessel by an energy device will greatly reduce the effectiveness thereof as a graft vessel, making it impossible to use the vessel as a graft. When engaging in dissection, therefore, the surgeon pays careful attention and progressively dissect only the trunk of the graft vessel while processing branches. Therefore, there is a demand to train in dissecting the internal thoracic artery in this way using an artificial blood vessel model.

3(1)(b) Blood Vessel Model Used for Training in ITA Dissection Techniques for Coronary Artery Bypass Surgery

The enoki-based blood vessel model presented in the first example is used as a blood vessel model (tubular organ) to train in ITA dissection techniques used in coronary artery bypass surgery.

This enoki-based blood vessel model may be solid or hollow in shape, as purpose demands.

An enoki blood vessel model used to train in graft vessel harvesting performed during coronary artery bypass procedures will be described below. It is vital that the enoki-based blood vessel model described below have sufficient strength against dissection, i.e., against tensile forces in the longitudinal direction, and be electrically conductive.

(Single Blood Vessel Model A)

A single blood vessel model has a single straight, tubular shape as shown in FIG. 4(a). The single blood vessel model A is fabricated from an enoki mushroom. The single blood vessel model A is used to train in cauterizing using an electric scalpel, suturing techniques using needle and thread, techniques for dissecting the surrounding tissue from the blood vessel model, and so forth.

Arteries and veins comprise branches. The trunk of a blood vessel having an outer diameter of 2 mm will have a range of branch sizes, about 0.1-1.0 mm, and the branch vessels will almost always be smaller in diameter than the trunk.

(Branched Blood Vessel Model B)

FIG. 4(b) depicts a model comprising branch blood vessels (branched blood vessel model B).

The branched blood vessel model B is fabricated by tearing the single blood vessel model to the necessary degree in the longitudinal direction and in the direction of the orientation of the fibers. The model is torn to a desired position to form a branch shape. A branched blood vessel model of this sort can be used as a vein model for EVH, or endoscopic vein graft harvesting.

The blood vessel can also be incorporated into an artificial model that reproduces fibers and other tissues surrounding the blood vessel (a gel/fibrous structure/resin/substrate or base model formed from elastic material), or applied to, bonded, sewn in place on, or implanted in (all of which correspond to the “anchoring” referred to in the present invention) animalian biological tissue to form an ITA dissection technique training model for coronary artery bypass surgery or robotic surgery.

(Branched Blood Vessel Model C) In a branched blood vessel model C according to another embodiment, two or more of the single blood vessel models A are used, as shown in FIG. 4(c).

Specifically, one blood vessel model A is used as a trunk vessel. At least one other blood vessel model A can be bonded, ligated, or otherwise connected to the trunk vessel at a desired branch site to reproduce a branched blood vessel. This model is used for the same sort of purposes as the blood vessel model B described above.

For example, this branched blood vessel model is disposed upon a flat substrate obtained by processing a comparatively large mushroom such as a king oyster, puffball, or wood ear, or artificial fibers or an artificial elastic material. The branched blood vessel model can then be bonded to or integrated with the substrate, etc., for use as a blood vessel model for dissection. Specifically, the blood vessel model is used to practice dissection from the substrate (matrix) using an electric scalpel, harmonic scalpel, or surgical instrument.

ITA harvesting training of this sort can be performed not only by a human, but also using a robot such as a da Vinci, in which case the model can be used to perform training in robotic ITA dissection. The blood vessel model can also be used not only for surgical training purposes, but also to evaluate the performance of a surgical robot constituting a medical device for carrying out this technique.

### 3(2) Applied Example 2: Training in Endoscopic Vein Harvesting (EVH) for Heart Surgery (Example 4)

3(2)(a) Endoscopic Vein Harvesting for Heart Surgery

One method for harvesting graft vessels for the coronary artery bypass procedure discussed above is endoscopic vein harvesting (EVH).

Endoscopic vessel harvesting (EVH) is a surgical method in which an endoscope is used to dissect and harvest the greater saphenous vein, radial artery, or the like. This technique uses a smaller incision than conventional vessel harvesting, but, being performed endoscopically, requires sufficient training to perform.

A simulator is used for EVH training. In the simulator, one practices dissection techniques for dissecting the trunk of the graft vessel from the surrounding tissue, and branch sealing techniques for cutting and sealing branches. Recent EVH devices in particular comprise bipolar electric scalpels at their distal ends, and simultaneously cut and cauterize branches and stop bleeding through coagulation. For this reason, the blood vessel model used in the simulator must be electrically conductive and have a branched structure and longitudinal strength. These are similar to the characteristics demanded of the ITA model described above.

3(2)(b) Organ Model for Use in Endoscopic Vein Harvesting Technique Training

As in the case of the ITA model, an enoki mushroom is used to obtain a blood vessel model for EVH training. For EVH, an organ model directed to dissection technique training, an organ model directed to branch sealing training, or an organ model that allows for simultaneous training in both (for example, the blood vessel models A, B, C shown in FIG. 4) is ideal.

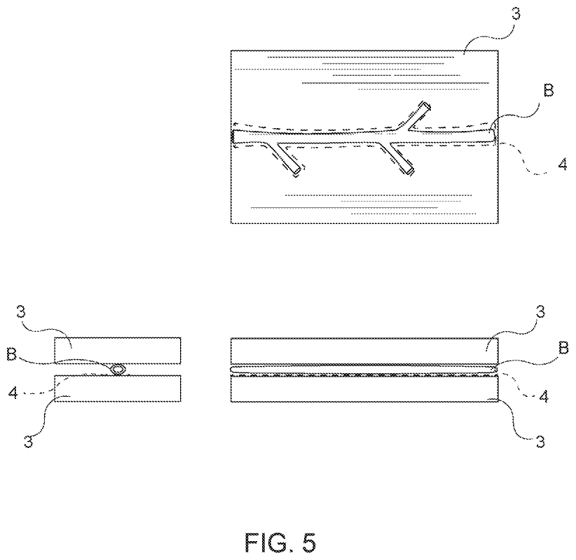

For example, FIG. 5 depicts the branched blood vessel model B described above bonded to and embedded in a substrate 3 obtained by working the stalk of a comparatively large mushroom, such as a king oyster mushroom, puffball, or wood ear mushroom, into a flat shape, thereby creating an artificial organ model for dissection technique training. The dotted line in the drawing represents an adhesive layer 4, and is preferably an adhesive interlining, but may also be a gel or elastomer adhesive.

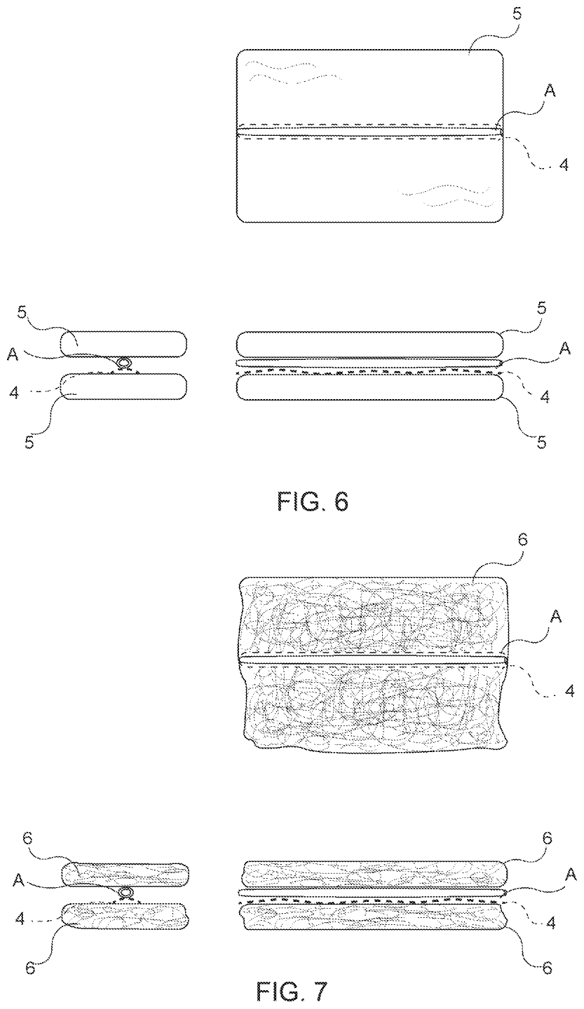

FIG. 6 depicts an example in which the single blood vessel model A is embedded in a substrate 5 obtained by shaping natural or synthetic fibers, an elastic material such as an elastomer, or a gel such as a hydrogel.

FIG. 7 depicts an example in which one or more fiber layer is used as a substrate 6.

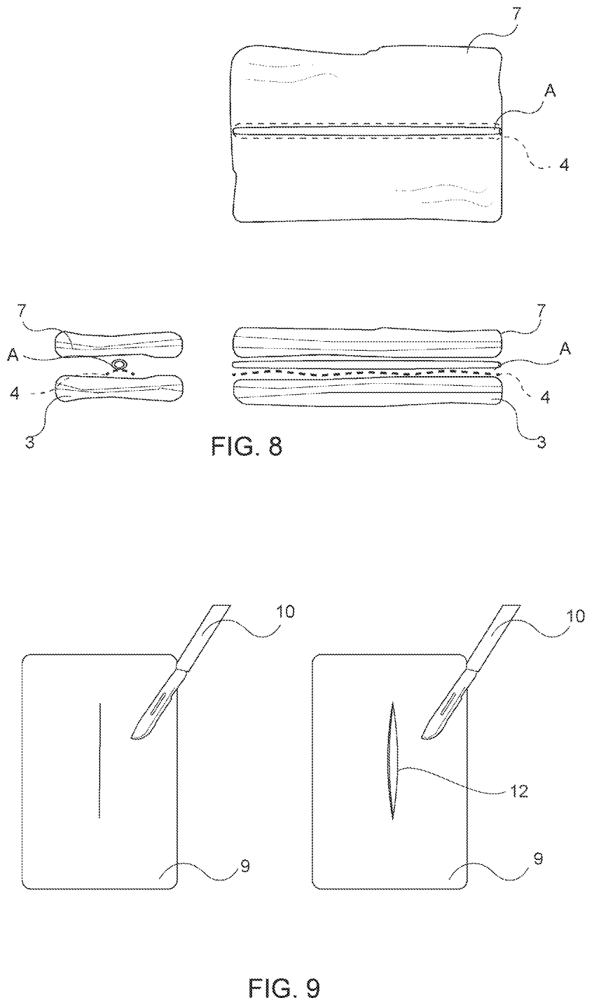

FIG. 8 depicts an example in which an animalian natural organ is used as a substrate 7.

In technique training, a dissection bit attached to the distal end of an endoscope is used upon the blood vessel models A-C bonded to the substrates 3, 5, 6, 7 to progressively physically and bluntly dissect the trunk and branches of the blood vessel model. During this process, the trunk and branches of the blood vessel model must not be physically damaged.

Once this dissection is complete, the trainee then transitions to the branch sealing process.

For an organ model directed to branch sealing techniques, it is ideal to use a branched blood vessel model anchored to a branched blood vessel model anchoring base constituted by a cylindrical tube of acrylic or other resin in which slits for anchoring branches have been formed. The interior space of the cylindrical tube can be used to reproduce an insufflated state in which the area around a graft vessel is filled with carbon dioxide or nitrogen gas during EVH. This organ model can be used to practice hemostatic techniques wherein the branches of the branched blood vessel model are gripped and cauterized using forceps comprising a built-in bipolar electric scalpel to coagulate blood at the ends of the branches.

### 3(3) Applied Example 2: Pediatric Heart Surgery Techniques—Training in Surgical Techniques for Ventricular Septal Defect (VSD) (Example 5)

3(3)(a) Pediatric Heart Surgery

Examples of problems presented by pediatric cardiovascular surgery include the small number of cases, and the face that congenital heart disease is accompanied by patient-specific anatomical characteristics, making it difficult to develop standardized surgical training. Ventricular septal defect (VSD) is a common congenital heart disease in the field of pediatric heart surgery.

Patients have congenital defects (holes) of a few centimeters in size in the left ventricle, and the mixture of venous blood with arterial blood causes symptoms such as hypoxia. One method for surgically treating this condition is VSD closure. Generally, visual access of septal defects in pediatric patients is obtained through open surgery. 5-0 or 6-0 size suture thread is used to sew about 12-16 stitches into the defect to close the defect (hole).

One conventional training method employed in recent years is to use a mold-cast three-dimensional resin organ model of the heart. Organ models of the heart made of elastic materials in which a 3D-printer is used to reproduce any desired shape are also available on the market. In this method, patient CT data is used to identify myocardial tissue on the basis of CT value features (segmentation), three-dimensional data is created for locations of presumed myocardial tissue (rendering), and a 3D printer performs 3D printing using an elastic material on the basis of the three-dimensional shape data to create a model that can be directly sutured by a surgeon (a model upon which techniques can be performed).

However, this existing method presents the problems of a complicated process and high manufacturing costs, and the difficulty in reproducing the fibrous mechanical properties of biological tissue in particular due to the limited materials that can be used with 3D printers.

Muscle tissue, such as myocardium, vascular tissue, and the like are made up of fibrous materials of high tensile strength, such as collagen, and are all oriented tissues. Such tissues are strong against external forces in the longitudinal direction (the direction in which the fibers are oriented), and weak against external forces that would pull the fibers apart, such as external forces in the circumferential direction in the case of blood vessels. Fungal fruiting bodies (mushrooms), which have the mechanical properties of being strong against tension in the direction of the fibers but extremely weak against longitudinal tearing forces, are ideal for reproducing this oriented nature of biological tissue.

The abovementioned ventricular septal defect surgery is characterized by the small cavities unique to pediatric patients, and the resultant small surgical field. This holds not only for the heart, but for the digestive tract, etc., as well, and the question of how to ensure the necessary surgical field, i.e., establish visual access, is vital for a stable procedure.

3(3)(b) Organ Model for Use in Pediatric Heart Surgery Technique Training

In this example, a king-oyster-based organ model is used to create an organ model directed to establishing visual access and suturing VSD defects in pediatric heart surgery in the pediatric chest cavity (likewise for the abdominal cavity in the field of gastrointestinal surgery, and the arms, thighs, and legs in the field of orthopedic and plastic surgery).

A human newborn has a height of about 50 cm and a body weight of about 2-3 kg. This equates to a length of about 20-30 cm for the chest and abdomen alone, which is a size that can be reproduced by king oyster stalks. The chest and abdomen of a child having a height of about 100 cm can also be reproduced. An arm, shin, foot, etc., of an adult can also be reproduced.

A comparatively large king oyster mushroom is used to reproduce the abovementioned pediatric chest cavity model. To this end, the cap of the mushroom is removed, as shown in FIGS. 1(a) and (b), to obtain an approximately 12 cm-wide, 15 cm-long, and 10-cm high shape resembling a block of tofu. In the treatment process in FIG. 1(c), the mushroom is microwaved at 200 W for 120 seconds in order to reduce structural strength. The treatment is not limited to microwaving; any treatment by which the cell walls can be suitably disrupted, such as a hot water bath, is acceptable. In a hot water bath, the model can be placed for five minutes or longer in water heated to at least 80° to obtain the desired pliability.

For example, the structure can be immersed in an aqueous solution of an aqueous paint for one hour to dye the structure to a depth of about 1 cm from the outer surface. The structure can be immersed in an aqueous solution containing a yellow paint and a white paint to reproduce the color and visual appearance of the surface of the skin, the dermis, and subcutaneous tissue structures.

3(3)(c) Example of Pediatric Heart Surgery Technique Training

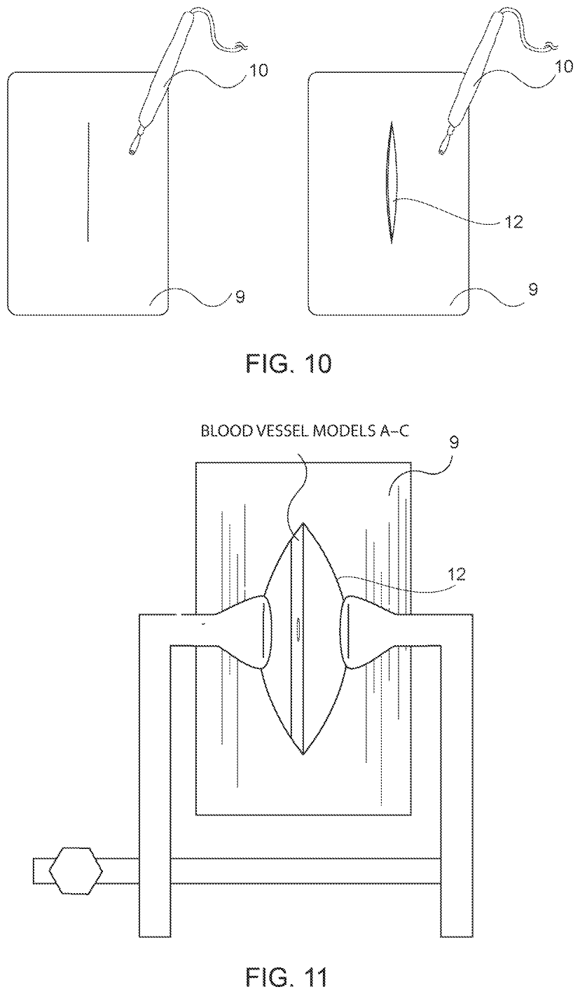

When using the mushroom chest cavity model described above to practice establishing visual access in pediatric heart surgery procedures and suturing VSD defects, a slit 12 is formed in the stained chest cavity model 9 fabricated as described above as shown in FIGS. 9 and 10, using a cutting instrument such as an electric scalpel 10 (FIG. 9) or a harmonic scalpel 11 (FIG. 10).

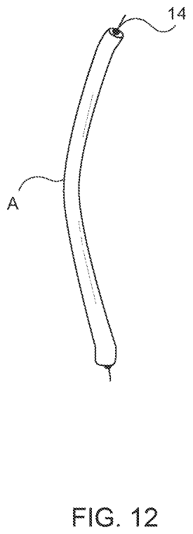

Models of the necessary organs, such as the aforementioned blood vessel models A-C made from enoki mushrooms, or a nerve model, ureter model, lymphatic vessel model, or the like obtained using a similar fabrication method, can then be disposed in the interior of the chest cavity model 9, as shown in FIG. 11. The organ models disposed in the interior of the chest cavity model 9 need not be artificial; for example, animal organs such as a pig carotid artery and bird intestines may also be used.

In other words, a comparatively large artificial organ made from a king oyster mushroom is ideal for reproducing human muscle tissue, adipose tissue, and the membrane tissues that connect the two, and models of tissues and organs upon which surgical techniques are performed can be precisely placed within the artificial organ to obtain a composite organ model that reproduces complex human tissue structures through this combination of models.

For a pediatric chest cavity model 9, it is preferable to dispose a pediatric heart model made of a small king oyster mushroom in imitation of the heart within a large king oyster mushroom. A VSD model can be placed in the chest cavity model to precisely reproduce the narrow open-chest surgical fields of children, which are smaller than in the case of adults, and technique training can be performed upon pathology models for ventricular/atrial septal defects or the like positioned therein.

### 4. Applied Examples of the Organ Model According to the Present Invention

### 4(1) Applied Example 1: Fabrication Method for Modified Mushroom Structural Strength Example 6

In this embodiment, the tear strength and elasticity of mushroom structures can be controlled through impregnation with, application of, or coating with other materials when fabricating the organ model. For example, a viscous and fluid liquid, such as a gel, a hydrogel, a sol, a hydrosol, an emulsion, or glycerol, is ideal as a modifying material.

For example, the pediatric chest cavity model 9 described above can be impregnated with an aqueous solution of sodium polyacrylate. In this case, a pediatric chest cavity model made from a king oyster mushroom is immersed for six hours in a 1% aqueous solution of sodium polyacrylate, then removed. Performing this modification process results in the tissue up to a depth of about 1 cm from the surface of the modified model 9 being permeated with the viscous liquid, making it possible to create an extremely realistic reproduction of human tissue when cutting into the modified model 9 with an electric scalpel.

### 4(2) Applied Example 2: Fabrication Method Incorporating an Actuator for Reproducing Heartbeat

While the examples described above illustrate methods of fabricating static organ models that do not reproduce any sort of movement, an actuator is incorporated into the distinctive fibrous structure of the mushroom in this example in order to reproduce tissues that actively beat or move, such as myocardium and muscles, and tissues that passively move as a result of heartbeats or respiration, such as blood vessels.

For this example, a method of fabricating an ITA heartbeat model using the blood vessel models A-C made from enoki mushrooms will be described.

In this example, as shown in FIG. 12, a 0.1 mm-diameter wire of primarily nickel-based shape memory alloy 2 is inserted into the hollow part of an ITA model A fabricated from an enoki mushroom, and anchored in place using fastening elements, such as surgical clips or staples, an adhesive, or the like on the ends of the enoki 1. The resistivity of the shape memory alloy is about 100-200 ohm/m, and a 5 V voltage can be applied to the two ends to heat the shape memory alloy and obtain approximately 5% expansion/contraction movement resulting from the heating of the shape memory alloy. Apart from a shape memory alloy, a motor, solenoid, dielectric, or the like may also be used as the actuator.

In accordance with the configuration and fabrication method described above, it is possible to use a mushroom to obtain an artificial organ model of a part or all of the human brain, the liver, the heart, a blood vessel, the neck, the chest, the abdomen, the arm, the thigh, a ureter, a nerve, a lymphatic vessel, the intestinal tract, or the like.

The structural pliability of mushrooms, their fragility against tearing loads in the fiber direction, their stainability and electrical conductivity, and the bountiful variety of shape options provided by different types of mushrooms—i.e., the morphological diversity of mushrooms—makes them ideally suited for organ models.

Moreover, using a mushroom as an artificial organ model eliminates the problems relating to sanitation, odors in room-temperature environments, and shelf life thanks to the fabrication method, which includes a preservative treatment and freeze-drying.

In view of the foregoing discussion, mushrooms have highly superior mechanical properties unique to fibrous structures, as well as electrical conductivity, stainability, compatibility with actuators, safety, and adaptability to modification through combination with other materials. In the case of a composite organ model, having the main structure be formed from a mushroom results in human-like electrical conductivity and anisotropic tear properties in response to mechanical stress loads such as incisions, and enables practical training in incision and dissection via electric scalpel, suturing, and retraction (countertraction) just like in actual surgical procedures. An organ model obtained as a result of establishing a fabrication method suitable for organ models will clearly make an optimal human organ model for surgical training and for actually evaluating related medical instruments.

The present invention is not limited to the example described above, and various modifications may be made thereto to the extent that they do not depart from the gist of the invention.

For example, while king oyster mushrooms and enoki mushrooms are mainly used in the embodiments described above, there is no limitation upon the type of mushroom as long as it is a comparatively large (often projecting) fruiting body or basidiocarp of a specific fungus.

1. An artificial organ model for surgical training, the model comprising a naturally grown or cultivated mushroom.

2. The artificial organ model according to claim 1, wherein:
the mushroom is shaped to a shape and size suitable for a specific organ being modeled, and is selectively colored before being subjected to a softening treatment;
thereby being processed so as retain material properties suitable for the organ being modeled.

3. The artificial organ model according to claim 2, wherein:
the softening treatment is heating the mushroom to a specific temperature for a specific length of time.

4. The artificial organ model according to claim 3, wherein:
the heating treatment is introducing the mushroom into water heated to 80° C. or higher for at least 60 seconds.

5. The artificial organ model according to claim 2, wherein:
the mushrooms are freeze-dried after being subjected to the aforementioned process.

6. The artificial organ model according to claim 2, wherein:
the mushroom has been impregnated with a preservative solution and subjected to a preservative treatment.

7. The artificial organ model according to claim 6, wherein:
the preservative solution is an aqueous solution of sodium hypochlorite, acidic water, an aqueous solution of sodium bicarbonate, an aqueous solution of chlorine dioxide, or PHMB (polyhexamethylene biguanide).

8. The artificial organ model according to claim 1, wherein:
the mushroom comprises a narrow stem-like stalk, which is used to model a thread-shaped organ such as a blood vessel, a nerve, a ureter, a lymphatic vessel, or the like.

9. The artificial organ model according to claim 8, wherein:
the narrow stem-like stalk is split along fibers thereof to imitate a branched thread-shaped organ model.

10. The artificial organ model according to claim 8, wherein:
a plurality of the narrow stem-like stalks is linked to imitate a branched thread-shaped organ.

11. The artificial organ model according to claim 8, wherein:
the thread-shaped organ modeled using the mushroom is anchored to a substrate or in the interior thereof.

12. The artificial organ model according to claim 10, wherein:
the substrate is formed by working a stalk of a mushroom other than that used to model the thread-shaped organ into a flat shape.

13. The artificial organ model according to claim 1, wherein:
the mushroom has a hollow shape.

14. The artificial organ model according to claim 1, wherein:
The specific organ being modeled is a part or all of the brain, the liver, the heart, a blood vessel, the neck, the chest, the abdomen, the arm, the thigh, a ureter, a nerve, a lymphatic vessel, the intestinal tract, or the like.

15. The artificial organ model according to claim 1, wherein:
the mushroom is a fruiting body or basidiocarp.

16. The artificial organ model according to claim 1, wherein:
the model is impregnated or coated with one or more of a polymer solution, a monomer solution, a hydrogel, a hydrosol, and an emulsion.

17. The artificial organ model according to claim 2, wherein:
the model comprises two or more different model organs modeled using two or more mushrooms; and
the two or more model organs are stacked in layers.

18. A method of fabricating an artificial organ model, the method comprising:
a step of shaping a specific type of mushroom into a shape a size suitable for a desired organ being modeled;
a step of selectively coloring the shaped mushroom with a color suitable for the organ being modeled; and
a step of performing a softening treatment upon the mushroom so that the mushroom retains material properties suitable for the organ being modeled.

19. The method of fabricating an artificial organ model according to claim 17, wherein:
the softening treatment is heating the mushroom to a specific temperature for a specific length of time.

20. The method of fabricating an artificial organ model according to claim 18, wherein:
the heating treatment is introducing the mushroom into water heated to 80° C. or higher for at least 60 seconds.

21. The method of fabricating an artificial organ model according to claim 17, further comprising:
a step of freeze-drying the processed mushroom.

22. The method of fabricating an artificial organ model according to claim 17, further comprising:
a step of impregnating the mushroom with a preservative solution and subjecting the mushroom to a preservative treatment.

23. The method of fabricating an artificial organ model according to claim 21, wherein:
the preservative solution is an aqueous solution of sodium hypochlorite, acidic water, an aqueous solution of sodium bicarbonate, an aqueous solution of chlorine dioxide, or PHMB (polyhexamethylene biguanide).

24. The method of fabricating an artificial organ model according to claim 17, wherein:
the mushroom comprises a narrow stem-like stalk, which is used to model a thread-shaped organ such as a blood vessel, a nerve, a ureter, a lymphatic vessel, or the like.

25. The method of fabricating an artificial organ model according to claim 23, further comprising:
a step of splitting the narrow stem-like stalk along fibers thereof to imitate a branched thread-shaped organ model.

26. The method of fabricating an artificial organ model according to claim 23, further comprising:
a step of linking a plurality of the narrow stem-like stalks to imitate a branched thread-shaped organ.

27. The method of fabricating an artificial organ model according to claim 23, further comprising:
a step of anchoring the thread-shaped organ modeled using the mushroom to a substrate or in the interior thereof.

28. The method of fabricating an artificial organ model according to claim 25, further comprising:
the substrate is formed by working a stalk of a mushroom other than that used to model the thread-shaped organ into a flat shape.

29. The method of fabricating an artificial organ model according to claim 17, further comprising:
a step of impregnating or coating the model with one or more of a polymer solution, a monomer solution, a hydrogel, a hydrosol, and an emulsion.

30. The method of fabricating an artificial organ model according to claim 17, further comprising:
a step of stacking in layers two or more different model organs modeled using two or more mushrooms.

31. A surgical technique training method utilizing the artificial organ model according to claim 1.
